(19) United States
(12) Patent Application Publication
(10) Pub. No.: US 2007/0222332 A1
(43) Pub. Date: Sep. 27, 2007

(54) Winding Support for an Electrical Machine

(76) Inventors: Gerald Roos, Sasbachried (DE); Harold Bitzer, Buehl (DE); Markus Rauschning, Buehl (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/578,411

(22) PCT Filed: Feb. 9, 2005
(86) PCT No.: PCT/EP05/50555

§ 371 Date: Oct. 13, 2006

(30) Foreign Application Priority Data
Apr. 15, 2004 (DE) 10 2004 018 208.6

(51) Int. Cl. H02K 1/24

(52) U.S. Cl. 310/269

(57) ABSTRACT

A winding support for an electrical machine embodied as a lamination packet and has a plurality of pole teeth each having a pole foot about which a winding can be disposed. Beginning at the face ends of the lamination packet, the pole feet have an increasing width. The result is graduations in the tooth width, and thus the tooth cross section is “rounded” and hence smaller in circumference. The winding wire thus becomes shorter, and as a result the resistance drops.

### PRIOR ART

The invention is based on a winding support for an electrical machine as generically defined by the preamble to claim 1. A winding support of this kind is embodied as a lamination packet and has a plurality of pole teeth. The pole teeth each have a pole foot, about which a winding can be disposed. The laminations are embodied with an always constant width. As a result of layering of the laminations one behind the other, the pole foot has a block about which the winding must be laid, resulting in a relatively great wire length.

### ADVANTAGES OF THE INVENTION

The winding support of the invention for an electrical machine, having the definitive characteristics of claim 1, has the advantage that because of graduations in the tooth width, the tooth cross section is “rounded”, and thus the circumference is less. This makes the winding wire shorter, and as a result the resistance drops. This makes higher efficiency possible. Or enables the use of a thinner wire. This is advantageous particularly with single-tooth windings, in which the copper filling in the slot chamber is slight. For that purpose a winding support is contemplated which is embodied as a lamination packet and has a plurality of pole teeth, which each have a pole foot about which a winding can be disposed, and in which the pole teeth have an increasing width, beginning at the face ends of the lamination packet.

In a preferred refinement, the laminations of the lamination packet, beginning at the face ends of the lamination packet toward the middle in the region of the pole feet, have an increasing width that is at its maximum in the middle. The result is an especially favorable ratio in terms of size and circumference.

Preferably, the winding support has a portion from which the pole teeth protrude radially, and outer circumferential regions of the portion which are located between adjacent pole teeth are located essentially on a circle. As a result of this geometry, the winding support is especially well suited as an armature or stator of a permanently excited direct current motor.

In an advantageous refinement, the pole teeth have pole heads, which are wider than the pole feet, and the pole heads have a constant width over the length of the winding support. The result is improved efficiency.

Preferably, the pole teeth, at least in the region of the pole feet about which the winding can be disposed, are provided at least on the face end with insulation masks. This is a space-saving provision for insulation. If the insulation masks have a portion, contacting the face ends of the pole feet, which is adjoined by two obliquely protruding fins, which conform to the side faces of the pole feet, the result is optimal insulation.

An especially space-saving refinements is obtained if the maximum width of the pole feet is essentially equivalent to the length of the winding support.

With a winding support of this kind, especially compact armatures are obtained. An electrical machine with a winding support of this kind is also quite small and yet still has quite good performance values.

Further advantages and advantageous refinements will become apparent from the dependent claims and the description.

### DRAWINGS

One exemplary embodiment is shown in the drawing and described in further detail in the ensuing description.

FIG. 1 shows an electrical machine in longitudinal section;

FIG. 2 shows an armature of FIG. 1 in an end view;

FIG. 3 shows one pole tooth of the armature in longitudinal section, along the section lines III-III in FIG. 2; and

FIG. 4 shows the pole tooth in a cross section along the section lines IV-IV in FIG. 2.

### DESCRIPTION OF THE EXEMPLARY EMBODIMENT

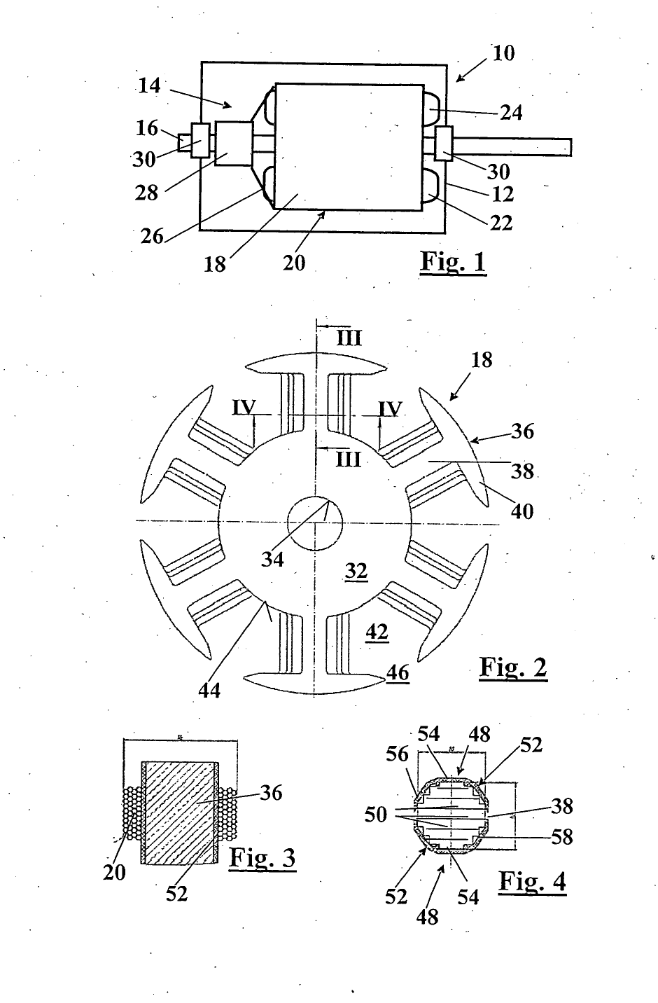

In FIG. 1, an electric motor 10 is shown in simplified form in a longitudinal section. The electric motor 10 may for instance, in a motor vehicle, be in a power window, seat motor, or the like. The electric motor 10 includes a housing 12 and an armature 14 disposed in the housing. The armature 14 has a shaft 16 and a winding support in the form of a lamination packet 18, with an armature winding 20, of which the protruding beads of two individual phase windings 22, 24 are shown. The phase windings 22, 24 communicate via wires 26 with a commutator 28. The shaft 16 is supported on the face ends of the electric motor 10 in two slide bearings 30.

In FIG. 2, the lamination packet 18 is shown in an end view, without the shaft 16 and the armature winding 20. Six pole teeth 36 protrude radially from an annular portion 32 that has a bore 34 for the shaft 16. It is also possible for more or fewer than six pole teeth 36 to be provided. The pole teeth 36 include a pole foot 38, adjoining the portion 32, and preferably a pole head 40 adjoining the pole foot, the pole head being wider than the pole foot 38. As a result, two adjacent pole teeth 36 form one undercut slot 42 for the armature winding 20. The slot bottom 44 located between each two adjacent pole teeth 36, or the outer circumferential region of the portion 32, is located essentially on a circle, and the transition between a slot bottom 44 and an adjacent pole foot 38 is preferably rounded and thus not located on the circle. It is also possible for the pole teeth 36 to be embodied with only a pole foot 38 but without a pole head 40.

The pole heads 40 are wider than the pole feet 38 but over the length of the lamination packet 18 they have a constant width. The result is a constant slot opening 46 of the slots 42, which has a favorable effect on the performance.

In FIG. 3, it is shown how a winding 20 is laid around a pole tooth 36. A single-tooth winding is especially suitable.

In FIG. 4, a pole foot 38 is shown in cross section, and thus its cross-sectional area is clearly shown. The pole feet 38 have an increasing width, beginning at the face ends 48 of the lamination packet 18. Preferably, the laminations 50 have an increasing width, beginning at the face ends 48 of the lamination packet 18 toward the middle in the region of the pole feet 38, and the maximum width is reached in the middle. It is entirely possible for all the laminations 50, which are shown only sketchily in FIG. 4, to be individually graduated. Simpler production, however, is attained if groups of laminations 50 of the same width are put together. This does produce greater graduation. However, the pole feet 38 nevertheless have a shape that approximates a circle. For that purpose it is appropriate if the maximum width of the pole feet 38 is essentially equivalent to the length of the lamination packet 18. Naturally, this covers production-caused deviations.

Alternatively, it is also conceivable for the lamination packet 18 to be longer than the width of the pole feet 38. However, in that case the construction is not so compact.

FIG. 4 also shows that the pole teeth 36, at least in the region of the pole feet 38 about which the winding 20 is disposed, are provided with insulation masks 52 at least on the face ends. The insulation masks 52 have a portion 54, contacting the face ends 48 of the pole feet 38, which portion is adjoined by two obliquely protruding fins 56, which conform to the side faces 58 of the pole feet 38. The fins 56 are embodied as flat and are preferably at an angle of 45° to the portion 54. A simpler construction is thus obtained.

Instead of the armature 18 shown, there may be a wound stator, such as an external rotor motor. Another possibility is an annular stator, for instance of a generator, with inward-oriented pole teeth.

1-10. (canceled)

11. In a winding support for an electrical machine, which winding support is embodied as a lamination packet and has a plurality of pole teeth each of which has a pole foot about which a winding can be disposed, the improvement wherein the pole feet, beginning at the face ends of the lamination packet, have an increasing width.

12. The winding support as defined by claim 11, wherein the laminations of the lamination packet, beginning at the face ends of the lamination packet toward the middle in the region of the pole feet have an increasing width and are widest at the middle.

13. The winding support as defined by claim 11, wherein the winding support comprises a portion from which the pole teeth protrude radially, and wherein outer circumferential regions of the portion which are located between adjacent pole teeth are located essentially on a circle.

14. The winding support as defined by claim 12, wherein the winding support comprises a portion from which the pole teeth protrude radially, and wherein outer circumferential regions of the portion which are located between adjacent pole teeth are located essentially on a circle.

15. The winding support as defined by claim 11, wherein the pole teeth comprise pole heads which are wider than the pole feet the pole heads having a constant width.

16. The winding support as defined by claim 12, wherein the pole teeth comprise pole heads which are wider than the pole feet the pole heads having a constant width.

17. The winding support as defined by claim 13, wherein the pole teeth comprise pole heads which are wider than the pole feet the pole heads having a constant width.

18. The winding support as defined by claim 11, wherein the pole teeth at least in the region of the pole feet about which the winding can be disposed, are provided at least on the face end with insulation masks.

19. The winding support as defined by claim 12, wherein the pole teeth at least in the region of the pole feet about which the winding can be disposed, are provided at least on the face end with insulation masks.

20. The winding support as defined by claim 13, wherein the pole teeth at least in the region of the pole feet about which the winding can be disposed, are provided at least on the face end with insulation masks.

21. The winding support as defined by claim 15, wherein the pole teeth at least in the region of the pole feet about which the winding can be disposed, are provided at least on the face end with insulation masks.

22. The winding support as defined by claim 18, wherein the insulation masks have a portion contacting the face ends of the pole feet, which portion is adjoined by two obliquely protruding fins which contact the side faces of the pole feet.

23. The winding support as defined by claim 12, wherein the insulation masks have a portion contacting the face ends of the pole feet, which portion is adjoined by two obliquely protruding fins which contact the side faces of the pole feet.

24. The winding support as defined by claim 13, wherein the insulation masks have a portion contacting the face ends of the pole feet, which portion is adjoined by two obliquely protruding fins which contact the side faces of the pole feet.

25. The winding support as defined by claim 15, wherein the insulation masks have a portion contacting the face ends of the pole feet, which portion is adjoined by two obliquely protruding fins which contact the side faces of the pole feet.

26. The winding support as defined by claim 11, wherein the maximum width of the pole feet is essentially equivalent to the length of the winding support.

27. The winding support as defined by claim 11, wherein the pole teeth are provided with a single-tooth winding.

28. An armature having a commutator and having a winding support as defined by claim 11.

29. An electrical machine having a winding support as defined by claim 11.

30. An electrical machine having an armature as defined in claim 28.
